(19) United States
(12) Patent Application Publication
(10) Pub. No.: US 2006/0031446 A1
(43) Pub. Date: Feb. 9, 2006

(54) Gathering network management data using a command line function

(76) Inventor: Mohamed Hamedi, Granite Bay, CA (US)

Correspondence Address: HEWLETT-PACKARD COMPANY;Intellectual Property Administration, P.O. Box 272400, Fort Collins, CO, 80527-2400, US

(21) Appl. No.: 10/870,724

(22) Filed: Jun. 17, 2004

(51) Int. Cl. G06F 15/173

(52) U.S. Cl. 709/223

(57) ABSTRACT

A method, system, and apparatus are disclosed for gathering network management data. Network data is gathered from a plurality of network-coupled data processing arrangements using a network management protocol. A command line status function is remotely executed on one or more of the data processing arrangements. Combined network data is formed based on the network data and a result of the command line status function. The combined network data is presented for use in a network management arrangement.

### FIELD OF THE INVENTION

The present disclosure relates to data processing, and in particular gathering of network management data.

### BACKGROUND

Computers have played an increasingly important role in all manners of business and personal activities. The increased adoption of personal computers has lead to an increased demand for various networks technologies that are used to connect the computers together for communications. Computer networks have become as important as the computers themselves, providing users worldwide connectivity via infrastructures such as the Internet.

Smaller groups of computers are often grouped into local area networks (LANs). LANs are useful in sharing data and devices with a subset of trusted users. Although LANs were initially used by large enterprises and academic institutions, the use of LANs has become much more widespread. LANs are now increasingly being used in homes and small businesses to connect computers and devices together.

For a small LAN, managing the network is fairly simple. Routers, switches, computers, and other devices can communicate use, for example, Dynamic Host Configuration Protocol (DHCP) for automatic configuration of network parameters. Various diagnostic tools (e.g., software) may also be run on computers connected to the LAN to troubleshoot some network problems.

However, in a large organization, there may be hundreds or thousands of computers interconnected via various networks. When network infrastructure becomes this complex, it becomes cumbersome for network managers to physically access various parts of the network for troubleshooting. Further, problems seen on one or more computers may be indicative of local problems or of a more widespread problem affecting the network.

The requirement of managing large and complex networks has led to the development of automatic network management tools. These tools can be used to continually monitor network performance for quick identification of problems. Network management tools may also be used to remotely configure certain devices on the network

Although network management software is useful, it often relies on an underlying standard protocol, such as Simple Network Management Protocol (SNMP). Although SNMP is extensible, the hardware deployed on the enterprise network may rely on different and/or incompatible SNMP configurations. Therefore it is likely that a network management system using SNMP alone may not be able to fully exploit the remote network management capabilities.

### SUMMARY

A method, system, and apparatus are disclosed for gathering network management data. Network data is gathered from a plurality of network-coupled data processing arrangements using a network management protocol. A command line status function is remotely executed on one or more of the data processing arrangements. Combined network data is formed based on the network data and a result of the command line status function. The combined network data is presented for use in a network management arrangement.

### BRIEF DESCRIPTION OF THE DRAWINGS

FIG. 1 illustrates a network management arrangement according to various embodiments of the invention;

FIG. 2 illustrates a network management system according to various embodiments of the invention;

FIG. 3 illustrates a Universal Modeling Diagram of a network management data tracker according to various embodiments of the present invention;

FIG. 4 illustrates a data tracking procedure according to various embodiments of the present invention; and

FIG. 5 illustrates a network configuration procedure according to various embodiments of the present invention.

### DETAILED DESCRIPTION

In the following description of various embodiments, reference is made to the accompanying drawings which form a part hereof, and in which is shown by way of illustration various example manners by which the invention may be practiced. It is to be understood that other embodiments may be utilized, as structural and operational changes may be made without departing from the scope of the present invention.

In general, the present disclosure relates to gathering network activity data using one or more network management protocols and combining that data with data gathered using command line interfaces (CLIs). This enables a network activity monitoring activity to gather additional information beyond that provided by the network management protocols in a way that is transparent to the end user.

Command line interfaces are flexible and may provide data that is more comprehensive than data provided by network management protocols. Also, CLIs can be easily customized and adapted to take advantage of new features and capabilities of network hardware and software. Therefore, by supplementing data gathered using network management protocols with command line data, a network management system can adapt to the newest features of the network.

One widely adapted network management protocol is SNMP. The SNMP framework contains two primary elements, agents and managers. Managers are the entities through which a network administrator may monitor and manage various aspects of the network. The agents are the entities that interface to the device being managed. Servers, switches and routers are examples of managed devices that may contain managed objects. These managed objects might track information relating to hardware, configuration parameters, performance statistics, and so on, that relate to the current operation of the device.

Managed objects are arranged in what is known as a virtual information database, called a management information base (MIB). SNMP provides a communications framework for accessing these objects. Although SNMP is transport independent, SNMP most commonly utilizes the User Datagram Protocol (UDP) and the Internet Protocol (IP). Since UDP/IP is a connectionless protocol, some functionality associated with reliable packet data transmission (e.g., sequencing, retransmission of erroneous data) is handled at a higher level in the SNMP applications. SNMP may also operate over Data Link Layer protocols such as Ethernet or Token Ring to implement communication channels from managers to agents.

The simplicity and connectionless nature of SNMP communication results in a robust system. The managers and agents may operate independently. Thus, a manager may continue to function even if a remote agent fails. When the agent resumes operation, the agent can send a trap to the manager, signalling a change in operational status.

Although SNMP is designed to operate automatically and in the background, a CLI is designed for human interaction. Therefore, as previously described, CLI commands are usually output to a terminal or other display, although it will be appreciated that the output can be redirected to other devices (e.g., files). An example of a CLI output for two commands submitted to a network switch are shown in Listings 1 and 2.

Command name: show flash

Example Result:

Code Flash Type: AMD 29F032B, Size: 64*65536=4194304, Unit: 2

Boot Flash Type: AMD 29F040, Size: 8*65536=524288

Compressed Pri Code size=3825509, Version 07.6.01bhpT53 (h2r07601bhp.bin)

Compressed Sec Code size=3507779, Version 07.5.04b20T53 (foundry/H2R07504b20.bin)

Maximum Code Image Size Supported: 3866112 (0x003afe00)

Boot Image size=242660, Version 07.05.01 (foundry/boot/M2B07501.BIN)

Used Configuration Flash Size=1145, Max Configuration Flash Size=262144.

### Listing 1

Command name: show version

Example Result:

SW: Version 07.6.01bhpT53 Hewlett-Packard Company
Compiled on Mar. 7, 2003 at 15:43:53 labeled as H2R07601bhp
(3825509 bytes) from Primary h2r07601bhp.bin
J4138A HP ProCurve Routing Switch 9308M

HW: ProCurve HP9308 Routing Switch, SYSIF version 21

### Listing 2

The command line user will typically scan output like that of Listings 1 and 2 to determine status. The “show flash” command in Listing 1 is used to determine the layout and contents of flash memory. The “show version” command in Listing 2 is used to determine the system hardware configuration, software version, and names and sources of configuration files and boot images. It will be appreciated that the both the inputs and outputs used to generate Listings 1 and 2 can be parsed by an automatic command line interface (CLI) engine. In this way, a computer program can gather network configuration and activity data by simulating a human user logging into the machine.

For example, the version number of the primary flash image may be obtained via SNMP. The command line information shown in Listing 1 can be compared against the SNMP version to verify that these versions are the same. Also, not all information of interest is available via SNMP, such as the secondary version of the flash image. So using SNMP or a CLI engine, it may be possible to determine how many images are available on the network device. Then the CLI can obtain data using the “show version” command shown in Listing 2 to get details regarding the secondary version.

It will also be appreciated that a CLI engine may also be used to control or configure a computing device. For example, the command line may be used to configure settings of a network switch, such as changing an IP address, disabling a port, setting system time, etc. These commands can be constructed by a CLI engine to provide control functions as well as the monitoring functions described above. The response obtained from the configuration command can be parsed by the CLI engine to determine whether the operation was successful.

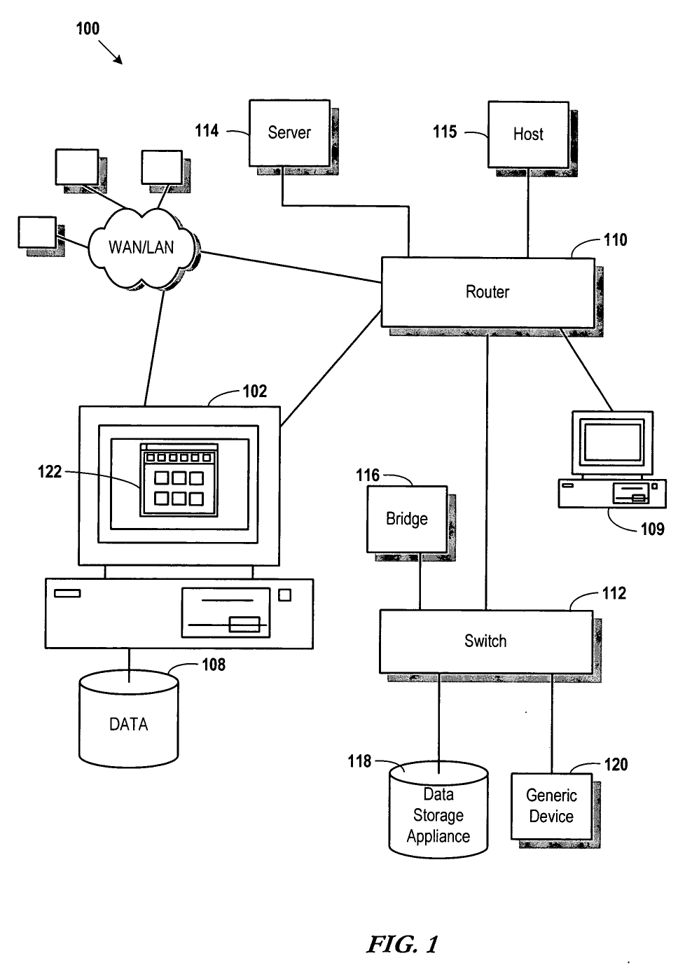

In reference now to FIG. 1, a network 100 includes a network data tracking arrangement (or data tracker) 102 according to embodiments of the invention. The network data tracking arrangement 102 can run on any number of data processing devices coupled to the network. The network data tracking arrangement 102 may be used for the automatic monitoring and control of devices on the network.

The data tracker 102 may include the capability to gather data using any current or future network management protocols, including Simple Network Management Protocol (SNMP), Cisco Discovery Protocol, (CDP), Foundry Discovery Protocol (FDP), Address Resolution Protocol (ARP), etc. The data gathered using these techniques may be used to populate a database 108. The data gathered may also be used in a network management arrangement 109 for display and/or control of the network 100.

The data tracker 102 also includes the ability to automatically initiate a command line session with any network entities, including routers 110, switches 112, servers 114, hosts 115, bridges 116, storage appliances 118, and any other network coupled device as represented by generic device 120. A command line session generally refers to data communications designed to allow a human operator locally or remotely interact with a computing device. A command line session may involve the exchange of any combination of text or binary data between a user input/output device and the target system. Command line sessions may be established with any text or binary session protocols known in the art, such as telnet, remote shell (rsh), secure shell (ssh), etc.

The command line sessions often exchange data formatted for display on a teletype or text terminal (e.g., VT100). However, it will be appreciated that other forms of data may be conveyed via a command line session, including graphical data (e.g., ncurses). In general, the data tracker 102 may include the capability to automatically interpret and respond to the data of a command line session as if the session were being run by a person.

The CLI is typically used to execute a command on a remote system. For example, on a Unix or Linux host, a shell command such as “ifconfig -a” will produce a text readout describing status of all the network interfaces on the host. From the output generated by the “ifconfig” command, the user can determine data about the interfaces, such as IP addresses, subnet masks, whether the interface is currently up or down, etc.

Data gathered using a CLI and network management protocols may be combined to provide a more complete picture of network status than using network management protocols alone. The combined data may be placed in a database 108, and/or sent directly to an output, such via a GUI 122. The database 108 and GUI 122 may present a unified “picture” of the combined data, such that the user need not be aware of how the data was gathered.

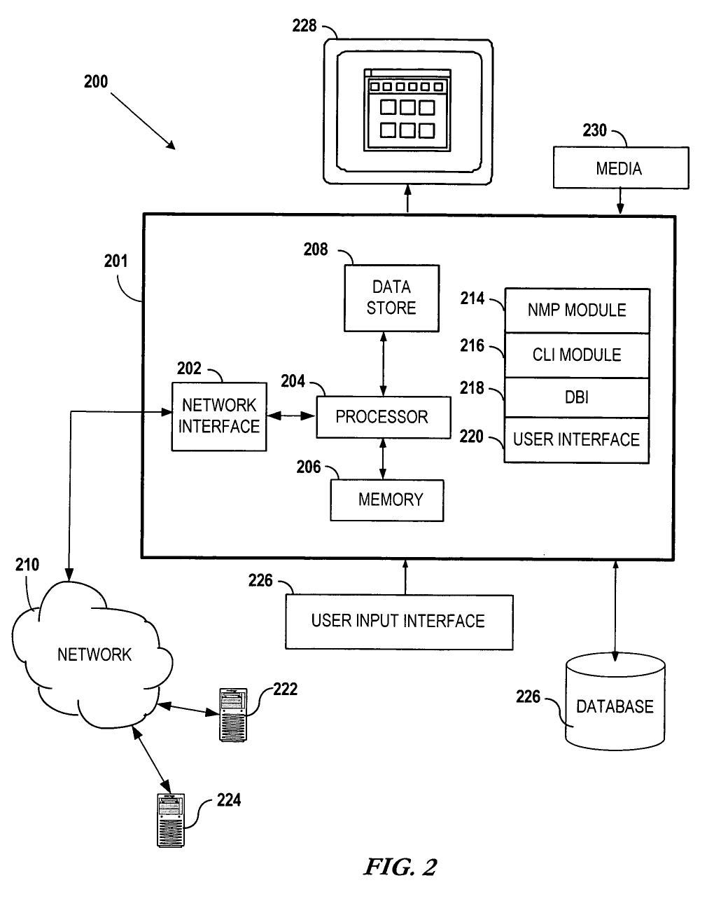

FIG. 2 illustrates a representative arrangement of a network data tracker arrangement 200 according to embodiments of the present invention. The data tracker arrangement 200 may be implemented on a processing arrangement 201 that includes a network interface 202, a processor 204, memory 206, and a persistent data store 208. The data tracker 200 may access various entities 222, 224 of the network 210 via network management protocols and command line interfaces. The data tracker 200 may include a locally connected or remotely accessible database 226.

The data tracker 200 includes functional modules 212 that may be implemented in any combination of hardware and software. The functional modules may include a network management protocol module 214, a command line interface (CLI) module 216, a database interface 218, and a user interface 220. The database interface 218 may be used to store and retrieve data from the database 226. The user interface 220 may be used to interact with a user via such devices as a user input interface 226 and a display 228.

The network management protocol module 214 and command line interface module 216 are adapted for retrieving respective network activity data via the network. The network management protocol module 214 gathers network activity via an established network management standard. For example, the network management protocol module 214 may gather SNMP data using custom made routines or using off-the-shelf SNMP libraries/modules. The CLI module 216 may also use off-the-shelf libraries for aspects of the command line interface (e.g., telnet libraries). The CLI module 216 can be expected to deal with a wide variety of computing platforms and commands, therefore the CLI module 216 should be easily modified and extended to adapt to changing requirements.

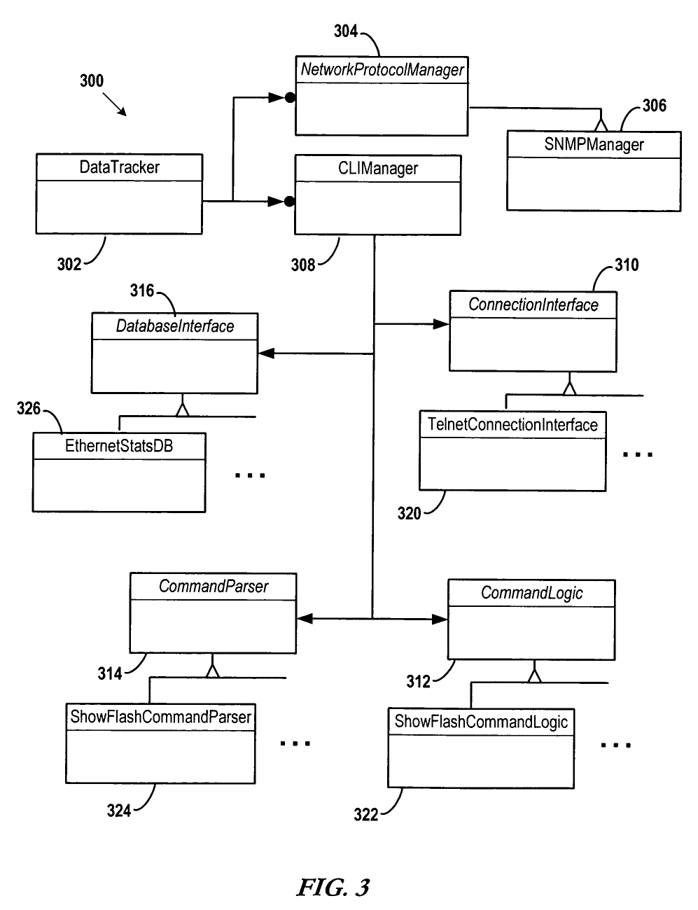

Example components of a data tracker according to embodiments of the invention is shown in FIG. 3. FIG. 3 includes a Universal Modeling Language (UML) diagram 300 showing components of a data tracker 302. The data tracker includes an network protocol manager 304 implemented as an abstract interface. Various specific objects may inherit from the network protocol manager 304, such as an SNMP manager 306. The SNMP manager 306 may be implemented using any combination of custom code and off-the-shelf software components.

The data tracker 302 may also include one or more CLI managers 308. The CLI manager 308 may be an abstract or concrete class, and is used to gather data from and/or send control commands to network entities via a command line interface. The CLI manager 308 may include a number of components that provide parts of this functionality, including a connection interface 310, a command logic interface 312, a command parser 314, and a database interface 316.

The connection interface 310 abstracts common connection methods used for establishing command line sessions. In the illustrated example, a telnet connection interface 320 inherits from the connection interface 320 to provide CLI connections via telnet. The telnet connection interface 320 may handle various telnet connection tasks, such as establishing TCP/IP connections to a telnet port on the specified hosts, handling logins (e.g., username and password), and establishing data channels (e.g., file descriptors) for use by the command logic and command parser interfaces 312, 314.

The command logic interface 312 and command parser 314 abstract various aspects of executing commands through a CLI. The command logic interface 312 deals with sequences and states of the commands. The command parser 314 parses data going to and from the CLI. It will be appreciated that the logic and parser interfaces 312, 314 may be combined into a single class, or one class may contain the other (e.g., the command logic class 312 may instantiate and use a command parser object 314). The command logic 312 and command parser 314 interfaces may be inherited by objects that perform specific command line functions. For example, a SetFlash command logic 322 and SetFlash parser 324 may be used to control a “set flash” command as shown in Listing 1.

The database interface 316 is a general purpose interface for storing and retrieving persistent data. The database interface 316 may store data on any type of storage system, including filesystems or relational databases. The database interface 316 may be adapted to store different types of data. For example, a typical use of the database interface 316 is to take network data collected by an instance of the command parser 314, convert the data to a specific database format, and store the formatted data. The formatted data may be combined in the database with data collected from the network protocol manager 304. For example, if a CLI manager 308 is used for collecting Ethernet statistics, the command parser 314 may use an Ethernet statistics database object 326 for storing this network data.

The database interface 316 may also be used for storing persistent data needed by other classes to operate. For example, the telnet connection interface 320 may utilize database entries to retrieve hostnames, usernames, and passwords of computers on the network that are accessible via telnet. Similarly, the command logic 312 and/or command parser 314 may store the text for various commands, as well as grammars used to parse those commands. This allows a particular command to be adapted for various systems without recompiling code.

For example, almost all Unix-like systems will give a list of the current shell's processes by using the “ps” command. However, to list all processes on the system, the options that follow the “ps” command may vary. Some flavors of Unix use “ps -ef,” and others use “ps aux” to show all processes. Therefore, the database may store localized options for each command in a database.

The data tracker 302 may determine the correct command version by determining the operating environment (e.g., operating system, version) of the target system The target operating environment can be determined statically (e.g., predetermined mapping of hosts to OS versions) and/or dynamically (e.g., using a command such as “show version”). Once the operating environment is determined, the data tracker 302 can configure a command logic 312 and command parser 314 to use the correct version of the command. Similarly, the output format of CLI commands may vary from system to system, and the command parser 314 may be configured with a grammar descriptor (e.g., regular expression) to extract the values of interest based on the target operating environment.

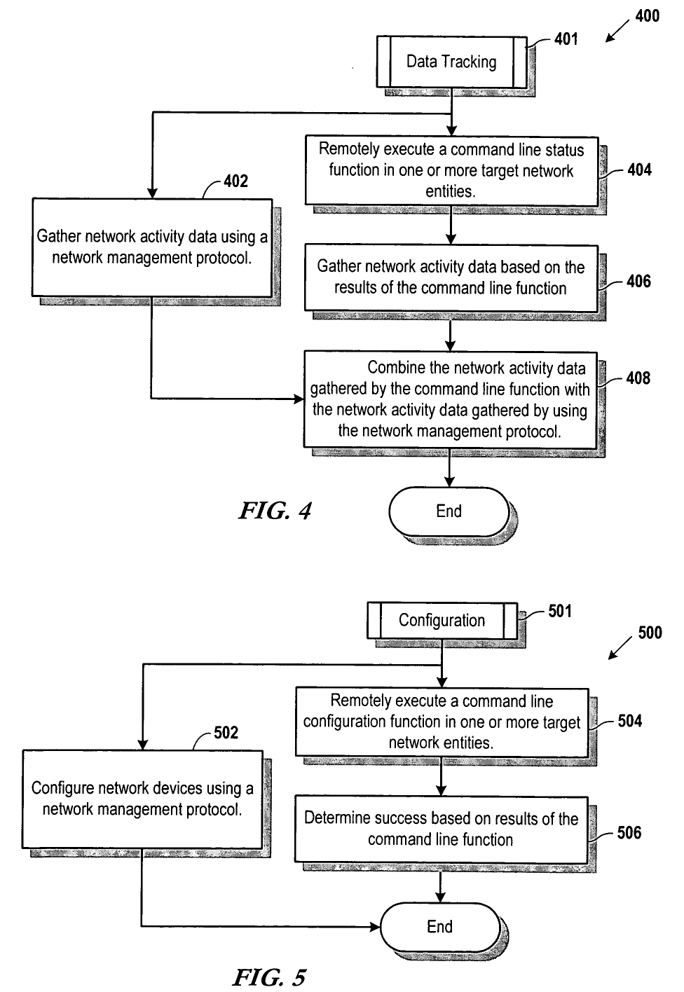

In reference now to FIG. 4, a flowchart 400 illustrates a procedure for tracking network data in accordance with embodiments of the present invention. The data tracking procedure 401 includes two processes that may operate in parallel. In one branch, network activity data is gathered (402) using a network management protocol. In the other branch, a CLI interface is used to remotely execute (404) a command line status function in one or more target network entities and gather (406) network activity data based on the results of the command line status function. The data from the two branches can be combined (408) for purposes of determining network activity.

It will be appreciated that the steps analogous to the steps in the flowchart 400 may be used to control and/or configure network entities. A flowchart 500 in FIG. 5 illustrates a procedure for configuring network devices in accordance with embodiments of the present invention. The configuration procedure 501 includes two processes that may operate in parallel. In one branch, network configuration is performed (502) using a network management protocol. In the other branch, a CLI interface is used to remotely execute (504) a command line configuration function in one or more target network entities. Success of the configuration is determined (506) based on the results of the command line configuration function.

Computer-executable instructions that perform functionality of the data tracker may be provided as software on any computer-readable medium, such as a diskette or a CD-ROM (e.g., media 230 in FIG. 2). The software may also be provided locally or remotely via a data transfer interface such as the network interface 202. From the description provided herein, those skilled in the art are readily able to combine hardware and/or software created as described with appropriate general purpose or system and/or computer subcomponents embodiments of the invention, and to create a system and/or computer subcomponents for carrying out the method embodiments of the invention. Embodiments of the present invention may be implemented in any combination of hardware and software.

The foregoing description of the example embodiments of the invention has been presented for the purposes of illustration and description. It is not intended to be exhaustive or to limit the invention to the precise form disclosed. Many modifications and variations are possible in light of the above teaching. It is intended that the scope of the invention not be limited with this detailed description, but rather the scope of the invention is defined by the claims appended hereto.

What is claimed is:

1. A processor-based method for gathering network management data, comprising:
gathering network data from a plurality of network-coupled data processing arrangements using a network management protocol;
remotely executing a command line status function on one or more of the data processing arrangements, the command line status function providing user-readable results describing status of the one or more data processing arrangements;
forming combined network data based on the network data and the results of the command line status function; and
presenting the combined network data for use in a network management arrangement.

2. The method of claim 1, wherein the network management protocol comprises the Simple Network Management Protocol.

3. The method of claim 1, wherein remotely executing the command line status function comprises establishing a telnet session with the one or more data processing arrangements.

4. The method of claim 1, wherein forming the combined network data comprises checking validity of the network data against the result of the command line status function.

5. The method of claim 1, wherein forming the combined network data comprises supplementing the network data with the result of the command line status function.

6. The method of claim 1, further comprising:
remotely executing a command line configuration function on the one or more data processing arrangements, the command line configuration function arranged to change settings of the one or more data processing arrangements; and
determining a success of the command line configuration function based on a result of the command line configuration function.

7. A system, comprising:
a plurality of data processing arrangements coupled via a network and configured to communicate via a network management protocol;
a tracking engine coupled to the network and configured to,
gather network data via the network using the network management protocol;
access one or more of the data processing arrangements via a command line interface;
execute a command line status function of the one or more data processing arrangements, the command line status function providing user-readable results describing status of the one or more data processing arrangements; and
form combined network data based on the network data and the results of the command line status function.

8. The system of claim 7, further comprising a data store coupled to the tracking engine and arranged to store the combined network data.

9. The system of claim 7, further comprising a network management arrangement coupled to the tracking engine and configured to present the combined network data.

10. The system of claim 7, wherein the network management protocol comprises the Simple Network Management Protocol.

11. The system of claim 7, wherein the tracking engine is configured to execute the command line status function by establishing a telnet session with the one or more data processing arrangements.

12. The system of claim 7, wherein the tracking engine is configured to form the combined network data by checking the validity of the network data against the result of the command line status function.

13. The system of claim 7, wherein the tracking engine is further configured to:
remotely execute a command line configuration function on the one or more data processing arrangements to configure the data processing arrangements, the command line configuration function arranged to change settings of the one or more data processing arrangements; and
determine whether configuring the data processing arrangements was successful based on a result of the command line configuration function.

14. A processor-readable medium, comprising:
a program storage device configured with instructions for causing a processor of a data processing arrangement to perform the operations of,
gathering network data from a plurality of data processing arrangements using a network management protocol;
remotely executing a command line status function on one or more of the data processing arrangements, the command line status function providing user-readable results describing status of the one or more data processing arrangements;
forming combined network data based on the network data and the results of the command line status function; and
presenting the combined network data for use in a network management arrangement.

15. The processor-readable medium of claim 14, wherein the network management protocol comprises the Simple Network Management Protocol.

16. The processor-readable medium of claim 14, wherein remotely executing the command line status function comprises establishing a telnet session with the one or more data processing arrangements.

17. The processor-readable medium of claim 14, forming the combined network data comprises checking the validity of the network data against the result of the command line status function.

18. The processor-readable medium of claim 14, the instructions further cause the processor of the data processing arrangement to:
remotely execute a command line configuration function on the one or more data processing arrangements, the command line configuration function arranged to change settings of the one or more data processing arrangements; and
determine a success of the command line configuration function based on a result of the command line configuration function.

19. An apparatus comprising:
means for gathering network data from a plurality of data processing arrangements using a network management protocol;
means for remotely executing a command line status function on one or more of the data processing arrangements the command line status function providing user-readable results describing status of the one or more data processing arrangements;
means for forming combined network data based on the network data and the results of the command line status function; and
means for presenting the combined network data for purposes of network management.

20. The apparatus of claim 19, further comprising:
means for remotely executing a command line configuration function on the one or more data processing arrangements, the command line configuration function arranged to change settings of the one or more data processing arrangements; and
means for determining a success of the command line configuration function based on a result of the command line configuration function.
